(19) United States
(12) Patent Application Publication
(10) Pub. No.: US 2006/0289733 A1
(43) Pub. Date: Dec. 28, 2006

(54) Stack-type image sensor module

(75) Inventors: Peter Zung, Hsin-Chu City (TW); Tzu-Han Lin, Hsin-Chu City (TW); Fang-Chang Liu, Hsin-Chu City (TW)

Correspondence Address: BACON & THOMAS, PLLC, 625 SLATERS LANE, FOURTH FLOOR, ALEXANDRIA, VA, 22314, US

(73) Assignee: VISERA TECHNOLOGIES, COMPANY LTD., HSIN-CHU CITY (TW)

(21) Appl. No.: 11/226,223

(22) Filed: Sep. 15, 2005

(30) Foreign Application Priority Data
Jun. 28, 2005 (TW) 94121692

(51) Int. Cl. H01J 5/02

(52) U.S. Cl. 250/239

(57) ABSTRACT

An image sensor module includes an image-sensing unit having a first surface, a second surface and a plurality of first conductive contacts arranged at the second surface, a signal processing unit mounted on the first surface of the image-sensing unit and provided with a plurality of second conductive contacts respectively electrically connected to the first conductive contacts of the image-sensing unit, a plurality of solder balls respectively electrically connected to the second conductive contacts of the signal processing unit for mounting in an external circuit board, and a lens set mounted on the second surface of the image-sensing unit and covering the first conductive contacts of the image-sensing unit.

### BACKGROUND OF THE INVENTION

1. Field of the Invention

The present invention relates to image sensor modules and more particularly, to a stack-type image sensor module.

2. Description of the Related Art

An electronic product such as a cellular telephone, PDA, or notebook computer may provide a digitalized photographic function. A photographic electronic product generally uses an image sensor for picking up images. A conventional image sensor is known having an image-sensing chip and a multichip module directly installed in a flexible PC board. The multichip module comprises a DSP (Digital Signal Processor), a memory chip and other electronic components. By means of the printed circuit board, the image-sensing chip and the multichip module are electrically connected for direct use in an electronic product.

In the aforesaid design of image sensor, a printed circuit board must be used to electrically connect the image-sensing chip and the DSP together, resulting in a big size of the image sensor. When used in an electronic product, the image sensor occupies much internal space of the electronic product. Thus, it becomes difficult to reduce the size of the electronic product.

### SUMMARY OF THE INVENTION

The present invention has been accomplished under the circumstances in view. It is the main object of the present invention to provide an image sensor module, which has the component parts bonded together in a stack, thereby reducing the whole dimensions for convenient application.

To achieve this object of the present invention, the image sensor module comprises an image-sensing unit having a first surface, a second surface and a plurality of first conductive contacts arranged at the second surface, a signal processing unit mounted on the first surface of the image-sensing unit and provided with a plurality of second conductive contacts respectively electrically connected to the first conductive contacts of the image-sensing unit, a plurality of solder balls respectively electrically connected to the second conductive contacts of the signal processing unit for mounting in an external circuit board, and a lens set mounted on the second surface of the image-sensing unit and covering the first conductive contacts of the image-sensing unit.

### BRIEF DESCRIPTION OF THE DRAWINGS

FIG. 1 is a schematic drawing showing the structure of a stack-type image sensor module according to a first preferred embodiment of the present invention.

FIG. 2 is a schematic drawing showing the structure of a stack-type image sensor module according to a second preferred embodiment of the present invention.

### DETAILED DESCRIPTION OF THE INVENTION

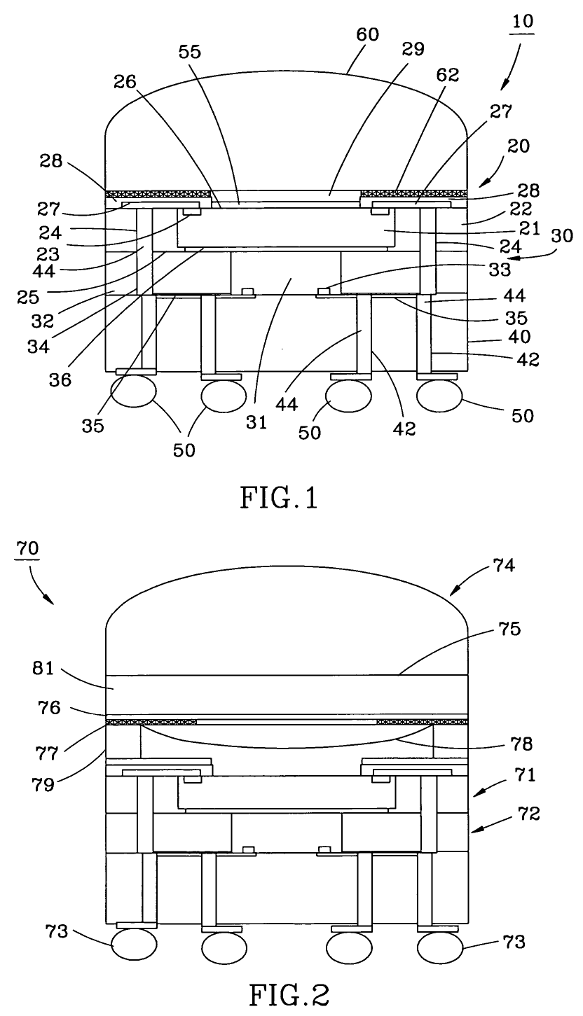

As shown in FIG. 1, a stack-type image sensor module 10 in accordance with the first preferred embodiment of the present invention comprises an image-sensing unit 20, a signal processing unit 30, a plurality of solder balls 50, and a lens set 60.

The image-sensing unit 20 comprises a photosensitive chip 21 and an encapsulant 22 encapsulating the photosensitive chip 21. The photosensitive chip 21 is a CMOS (complementary metal-oxide semiconductor) chip. The encapsulant 22 is formed of epoxy resin. The photosensitive chip 21 has a plurality of contact pads 23. The encapsulant 22 has a plurality of plated through holes 24 extending through a first surface 25 and a second surface 26 of the encapsulant 22 and electrically respectively connecting the contact pads 23 through a plurality of first conductive contacts 27 which are laid on the second surface 26 and electrically connected to the contact pads 23 for redistributing the contact pads 23. The image-sensing unit 20 is made by means of WLCSP (Wafer Level Chip Scale Package) technology. The photosensitive area and contact pads 23 of the photosensitive chip 21 are exposed to the outside of the second surface 26. The second surface 26 is covered with a passivation layer 28. The passivation layer 28 is covered on the first conductive contacts 27, defining a partition space 29 right above the photosensitive chip 21. A shield 55 is fastened to the second surface 26 of the image-sensing unit 20 and located in the partition space 29 to protect the photosensitive area of the photosensitive chip 21 that lays open to the outside of the second surface 26.

The signal processing unit 30 comprises a DSP (Digital Signal Processor) 31 and an encapsulant 32. The encapsulant 32 is formed of epoxy resin. The DSP 31 has a plurality of contact pads 33. The encapsulant 32 has a plurality of through holes 34 for electrically connecting the contact pads 33. The signal processing unit 30 is made by means of WLCSP (Wafer Level Chip Scale Package) technology, having a plurality of second conductive contacts 35 that are arranged at the bottom side of the signal processing unit 30 to redistribute the contact pads 33. By means of a glue 36, the signal processing unit 30 is attached to the first surface 25 of the image-sensing unit 20, so that the photosensitive chip 21 and the digital signal processor 31 are stacked together, keeping the plated through holes 34 of the encapsulant 32 of the signal processing unit 30 respectively electrically connected to the plated through holes 24 of the encapsulant 22 of the image-sensing unit 20.

The signal processing unit 30 is provided at the bottom side thereof with a substrate 40 formed of epoxy resin. The substrate 40 has a plurality of plated through holes 42 through the top and bottom surfaces thereof. Some through holes 42 of the substrate 40 are respectively connected to the through holes 34 of the signal processing unit 30. The through holes 34 of the signal processing unit 30, the through holes 24 of the image-sensing unit 20 and the through holes 42 of the substrate 40 are provided with a conductive material 44 such that the first conductive contacts 27 at the image-sensing unit 20 are electrically connected to the second conductive contacts 35 at the signal processing unit 30. The solder balls 50 are provided at the bottom side of the substrate 40 corresponding to the through holes 42 and respectively electrically connected to the second conductive contacts 35 at the signal processing unit 30 by the conductive material 44.

The lens set 60 is made of polymer by UV replication process and bonded to the passivation layer 28 of the image-sensing unit 20 with a glue 62, such that the lens set 60 is located above the photosensitive chip 21.

When using the image sensor module in an electronic product, the solder balls 50 can directly be bonded to the circuit board of the electronic product, allowing the lens set 60 and the image-sensing unit 20 to receive external incident light and to produce a corresponding electric signal for further processing by the signal processing unit 30. Thus, the electronic product has an image pickup function. Because the image-sensing unit 20, the signal processing unit 30 and the lens set 60 are made by means of WLCSP technology and stacked together, the whole structure of the image sensor module 10 has a small size convenient for installation with other electronic components in an electronic product's circuit board.

By means of the aforesaid arrangement, the invention achieves the object of reducing the size of the sensor chip module and facilitating its application.

FIG. 2 shows an image sensor module according to the second preferred embodiment of the present invention. According to this embodiment, the stack-type image sensor module 70 comprises an image-sensing unit 71, a signal processing unit 72, a plurality of solder balls 73, and a lens set 74. The main feature of this embodiment is that the lens set 74 has the bottom surface 75 bonded with a transparent plate member 81, an IR-cut filter 76, an aperture 77, and a concave lens 78. A spacer 79 is sandwiched between the lens set 74 and the image-sensing unit 71. The IR-cut filter 76 removes infrared rays from incident light. The arrangement of the filter 76, the aperture 77 and the concave lens 78 increase the optical characteristics of the image sensor module 70. This second embodiment also achieves the object of the present invention.

What is claimed is:

1. An image sensor module comprising:
an image-sensing unit having a first surface, a second surface, and a plurality of first conductive contacts arranged at said second surface;
a signal processing unit mounted on the first surface of said image-sensing unit, said signal processing unit having a plurality of second conductive contacts respectively electrically connected to the first conductive contacts of said image-sensing unit;
a plurality of solder balls respectively electrically connected to the second conductive contacts of said signal processing unit; and
a lens set mounted on the second surface of said image-sensing unit and covering the first conductive contacts of said image-sensing unit.

2. The image sensor module as claimed in claim 1, wherein said image-sensing unit comprises a photosensitive chip, which is a complementary metal-oxide semiconductor, on which said lens set is covered, said photosensitive chip having a plurality of contact pads respectively electrically connected to the first conductive contacts of said image-sensing unit.

3. The image sensor module as claimed in claim 1, wherein said signal processing unit comprises a digital signal processor having a plurality of contact pads respectively electrically connected to the second conductive contacts of said signal processing unit.

4. The image sensor module as claimed in claim 1, wherein said image-sensing unit and said signal processing unit have a plurality of through holes respectively coated with a conductive material for electrically connecting between the first conductive contacts and the second conductive contacts.

5. The image sensor module as claimed in claim 1, wherein said signal processing unit has a substrate on which said solder balls are arranged.

6. The image sensor module as claimed in claim 1, further comprising a filter layer set between said lens set and said image-sensing unit for removing infrared rays from the light passing therethrough.

7. The image sensor module as claimed in claim 1, further comprising an aperture set between said lens set and said image-sensing unit.

8. The image sensor module as claimed in claim 1, further comprising a spacer set between said lens set and said image-sensing unit, said spacer holding therein a lens.
